(19) United States
(12) Patent Application Publication
(10) Pub. No.: US 2010/0107574 A1
(43) Pub. Date: May 6, 2010

(54) Force distributing interface system

(76) Inventor: Dave Rajewski, Airway Heights, WA (US)

Correspondence Address: WELLS ST. JOHN P.S., 601 W. FIRST AVENUE, SUITE 1300, SPOKANE, WA, 99201, US

(21) Appl. No.: 12/290,657

(22) Filed: Oct. 31, 2008

(51) Int. Cl. A47C 20/02; B68C 1/12; B68B 7/00

(52) U.S. Cl. 54/66; 5/653

(57) ABSTRACT

A mammal interface system, an apparatus and method, providing a housing, a formable material within the housing which is molded into a customed fitted interface which redistributes forces transmitted to the mammal.

### CROSS REFERENCE TO RELATED APPLICATION

This application does not claim priority from any other application.

### TECHNICAL FIELD

This invention pertains to a force distributing interface system primarily intended for interfacing with mammals. More particularly, a custom formed mammal interface to distribute forces and reduce or eliminate pressure points on mammals.

### BACKGROUND OF THE INVENTION

For as long as humans and other mammals have been interfacing or interacting with objects of all kinds, there has been a long felt need and desire for an improved interface which buffers and distributes forces and pressures to eliminate elevated pressure points and sore spots.

One example of many is the interface between a horse or other animal that is ridden and the forces imposed on that animal such as those imparted on the animal through what is commonly referred to as a saddle. Many, most or all horse saddles create one or more pressure points of different magnitudes, which cause sore spots and areas where excess pain is inflicted on the animal. In rodeos and roping for example, these pressure points and sore spots may dramatically affect the performance of the animal.

Those familiar with horses for instance recognize that there are sweat patterns on their backs once the saddle, blanket and pad are removed. Spots or areas develop on the animals which may appear as a lighter colored area, spot. Sometimes this is referred to as a white spot on the horses hide (and hair) and is a location where excess force and pressure has been applied to the horse through the saddle, typically over time. These areas become recognizable because the horse eventually stops sweating in those locations and the hide and hair becomes discolored—and the discoloration is typically a lighter color. This also becomes evident through an inspection of the sweat patterns or lack of sweat in those areas when inspecting the blanket removed from the horse after exercise or work.

In some cases it is believed that a horse will buck, stop or respond very negatively to avoid further pain in that area. The horse's defensive response may, in some situations, cause injury to a rider if it acts in an unexpected way or dangerous way to the rider.

While the primary example referred to herein for embodiments of the invention relates to an interface or pad between a saddle and a horse, it should be noted that this invention is not thereby limited, but instead may provide mammal interfaces for numerous other applications. A few examples of other embodiments of this invention, may be a seat pad for a human to sit on a bleacher or a tractor for example, or a hand pad to place between a human hand and an object against which is it pressed.

There have been numerous prior attempts to provide an interface or relief for mammals from sources of pressure, such as through padding and other means between the source of the force and the mammal. While these prior attempts may provide additional cushion from the forces, they generally do not eliminate or greatly reduce the force imposed on the mammal to the extent this invention does. Furthermore, in many cases merely adding additional padding or gel causes an undesirable interface with the mammal. For example if one were to put a two or three inch thick pad between a horse and a saddle, this would cushion the force imposed on the horse, but would create an unacceptably loose interface and would not provide a secure solid feeling of the saddle being firmly and securely on the horse. It would also likely still provide the sore spots, it would just be more padded at the pressure point.

It is an object of some embodiments of this invention to provide a force distributing mammal interface system which reduces, greatly reduces or eliminates pressure points and force concentration points on the mammal via a custom fitted system wherein the interface is configured to receive that force at other locations and/or to better distribute that force over a larger area. For instance if a force would otherwise be applied in one or more local or small areas, customizing this mammal interface system may cause that force to be distributed to a different area or over a wider surface area on the mammal, thereby relieving significant pressure and pain.

It will also be noted that because embodiments of the interface system provided by this invention are customized between an individual mammal and an object or objects interacting with that mammal, it will be important to also provide in some embodiments a location system to provide a consistent way of locating the interface system relative to the mammal or the object resource of force imparted on the mammal. For example if a saddle pad is provided that saddle pad would be customized for one saddle on one horse. It would therefore be desirable that the pad is consistently placed in the same location relative to the saddle and to the horse so that the custom interface formed properly utilized and functions according to plan and design. It is therefore also a further object of some embodiments of this invention to provide such a mammal interface system which includes a location system so as to consistently place the interface where it is desired and where it functions as intended.

While the invention was motivated in addressing certain identified problems or desired advantages, it is not so limited. The invention is only limited by the accompanying claims as literally worded, without interpretative or other limiting reference to the specification, and in accordance with the doctrine of equivalents.

Other objects, features and advantages of this invention will appear from the specification, claims, and accompanying drawings which form a part hereof. In carrying out the objects of this invention, it is to be understood that its essential features are susceptible to change in design and structural arrangement, only practical and preferred embodiment being illustrated in the accompanying drawings, as required.

### BRIEF DESCRIPTION OF THE DRAWINGS

Preferred embodiments of the invention are described below with reference to the following accompanying drawings.

FIG. 1 is a perspective view of a mammal (a horse) with a saddle blanket, prior art saddle pad and saddle mounted thereon;

FIG. 2 is an elevation cross-sectional partial view of a prior art saddle, saddle pad and blanket on a horse;

FIG. 3 is a bottom view of one example of an embodiment of this invention which may be utilized as a saddle pad interfacing to a saddle and a horse;

FIG. 4 is a bottom partial view of an example of an embodiment of this invention wherein the interface system (saddle pad in this example) is being filled with the formable material to provide the custom interface;

FIG. 5 is a bottom partial view of an embodiment of this invention and a schematic representation of one example of mixing two materials to provide a formable material to the internal cavity of the saddle pad in this example;

FIG. 6 is a partial elevation cross-sectional view of an example of an embodiment of this invention after the formable material is placed in the internal cavity and before it is custom formed for the application;

FIG. 7 is a perspective exploded view of an example of a mammal interface system contemplated by embodiments of this invention, showing a saddle, a saddle pad and a blanket as it is placed on a horse to custom form the mammal interface system;

FIG. 8 is a perspective exploded view of an example of a mammal interface system contemplated by embodiments of this invention, showing a saddle, a saddle pad and a blanket as it is removed from the horse after it has been custom formed as a mammal interface system;

FIG. 9 is a top perspective view of the embodiment of the mammal interface illustrated in FIG. 8;

FIG. 10 is a partial elevation cross-sectional view of the mammal interface system illustrated in FIG. 9 showing differing areas and of force or pressure in the custom fit configuration provided;

FIG. 11 is detail 11 from FIG. 10;

FIG. 12 is another partial elevation cross-sectional view of the mammal interface system illustrated in FIG. 9, further showing areas and magnitudes of force contributing to the forming of the resulting interface;

FIG. 13 is a bottom perspective view of an example of an embodiment of a mammal interface system contemplated by this invention, namely a saddle pad customized for use with one saddle on one horse;

FIG. 14 is a top view of the example of the embodiment of the invention illustrated in FIG. 13;

FIG. 15 is a top view of a connector between two different parts of the example of the embodiment of the invention shown in FIG. 13;

FIG. 16 is an elevation cross-sectional view of one example of a sealable input aperture which may be utilized to insert formable material into the internal cavity of embodiments of interface systems contemplated by this invention;

FIG. 17 is an elevation cross-sectional view of another example of an input aperture which may be utilized to insert formable material into the internal cavity of embodiments of interface systems contemplated by this invention;

FIG. 18 is is an elevation cross-sectional view of another example of an input aperture which may be utilized to insert formable material into the internal cavity of embodiments of interface systems contemplated by this invention, with FIG. 18 showing the use of hook and loop (“Velcro”) to seal the aperture after the formable material has been inserted into the internal cavity;

FIG. 19 is an exploded perspective view of another embodiment of this invention which provides a location system for consistently locating interface systems contemplated by this invention relative to the mammal, and in this example, the saddle;

FIG. 20 is an elevation view of another embodiment of this invention wherein the interface system is provided as an interface between a human and a tractor seat; and

FIG. 21 is an elevation view of another embodiment of this invention wherein the interface system is provided as an interface between a human and a bleacher on which the human is sitting.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

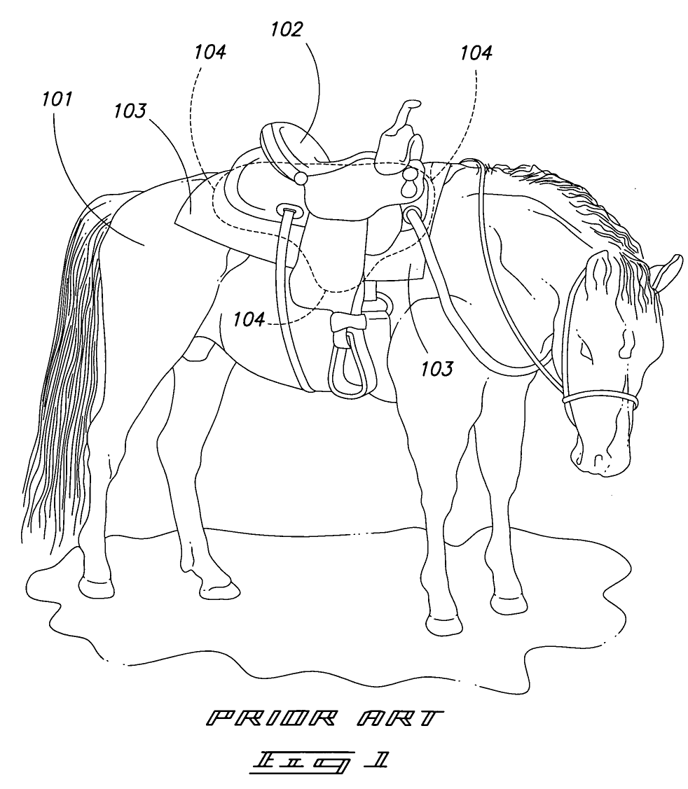

FIG. 1 is a perspective view of a mammal 101 (a horse) with a saddle blanket 103, prior art saddle pad 104 and saddle 102 mounted thereon. FIG. 1 illustrates how a common saddle 102 is mounted on a horse 101 with a blanket 103 directly on the horse, a saddle pad 104 on the blanket 103, with the saddle 102 mounted over the top of the saddle pad and the blanket, and then strapped around the horse.

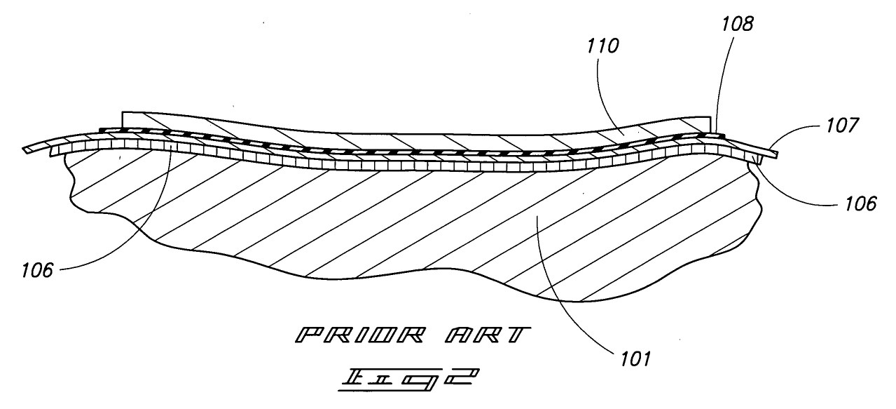

FIG. 2 is an elevation cross-sectional partial view of a prior art saddle 110, saddle pad 108 and blanket 107 on a horse 101 and interfacing with the hide 106 (or skin) of the horse 101. It can be seen that the blanket 107 and pad 108 are generally uniform and merely provide cushioning. It can further be seen that pressure applied in localized areas or points by the saddle 110 may be cushioned, but they will be directly transmitted to the horse 101.

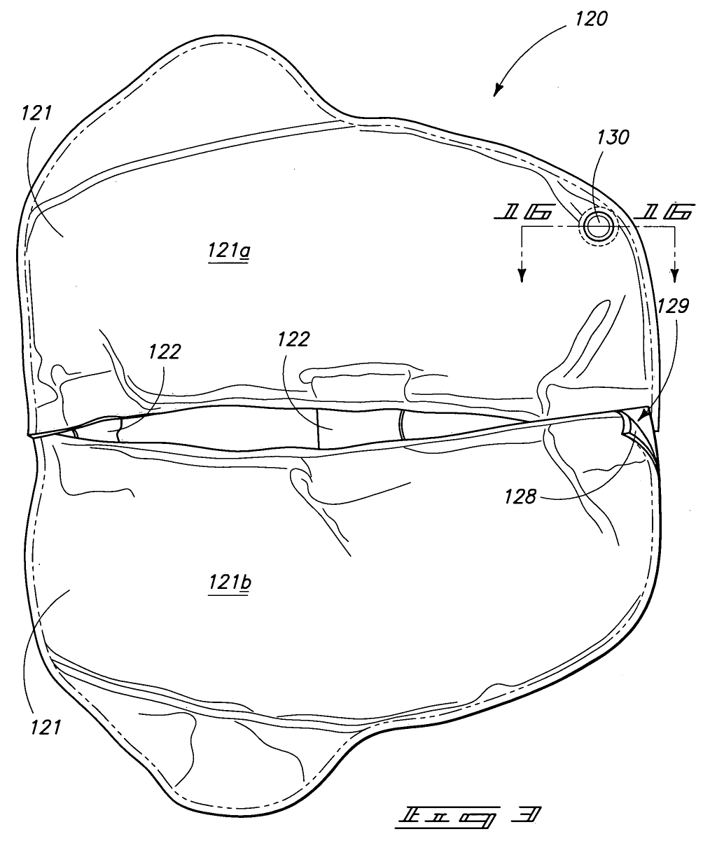

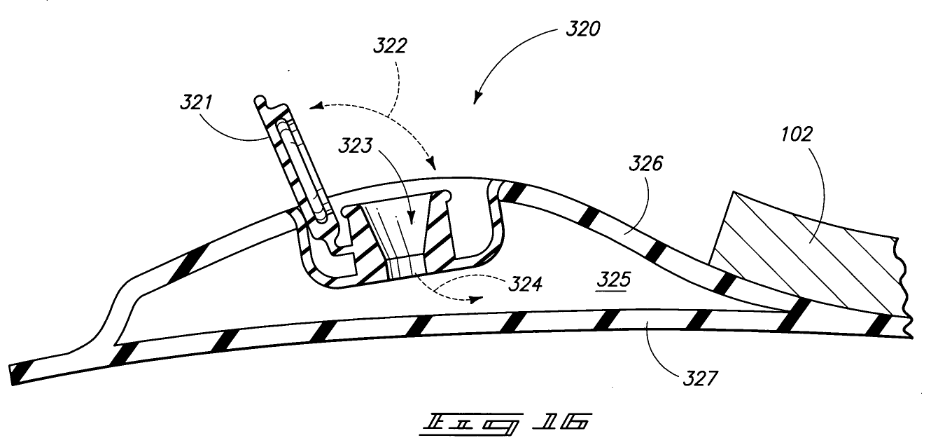

FIG. 3 is a bottom view of one example of an embodiment of an interface system contemplated by this invention which may be utilized as a saddle pad 120 which is configured to interface between a saddle and a horse (or the blanket on the horse). FIG. 3 illustrates saddle pad housing 121 (interface system housing), with first side saddle pad housing 121a and second side saddle pad housing 121b, with connectors 122 between the two. Input valve 130 is shown as one alternative aperture through which to put the formable material into the saddle pad housings 121a and 121b. A second exemplary input aperture 128 is shown on second side saddle pad housing 121b wherein the housing is not sewn or attached on the corner to thereby provide or leave an input aperture through which the formable mixture can be inserted before the aperture is closed. Arrow 129 shows directionally where the formable mixture would be inserted, which would be the equivalent of the aperture in the input valve 130 (as more fully shown in FIG. 16).

It will be noted that while the term housing is used herein, it is intended in the broad sense of a container for the moldable material and generally contains or houses the material primarily before the moldable material solidifies or reaches if desired form or configuration.

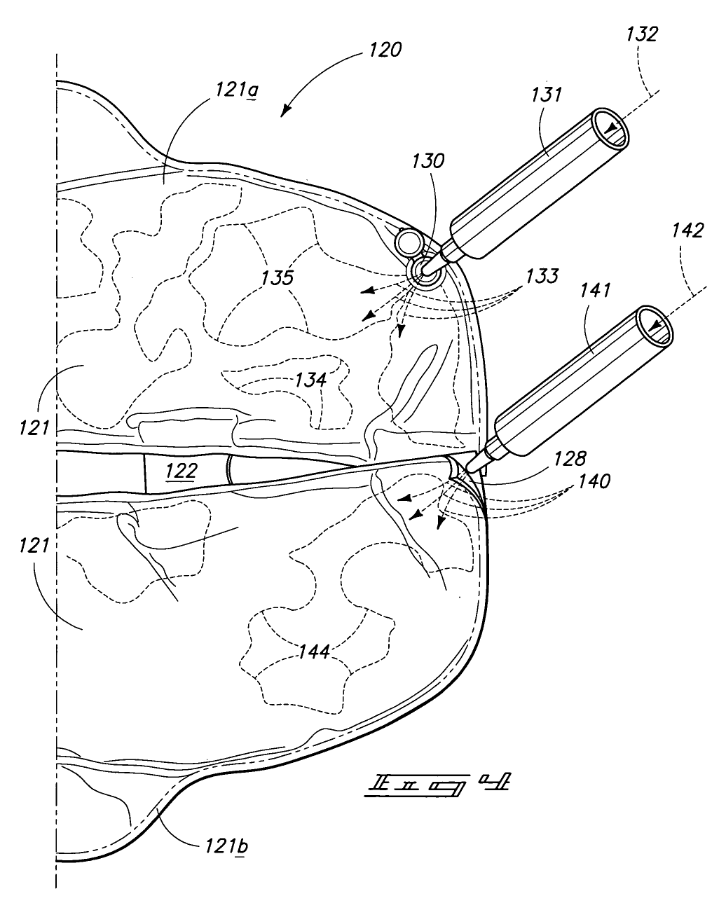

FIG. 4 is a bottom partial view of an example of an embodiment of this invention wherein the interface system (saddle pad 120 in this example) is being filled with the formable material to provide the custom interface. FIG. 4 includes like numbered items from FIG. 3 and not all items will be repeated here. FIG. 4 shows an exemplary input of formable or moldable material into second side saddle pad housing 121b through input aperture 128 and arrows 140 are used to show movement of formable material inside the saddle pad housing as received from insertion tool 141, which receives formable material as indicated by arrow 142. This is the first exemplary fill option shown in FIG. 4.

The second fill option shown in FIG. 4 utilizes insertion device 131 which receives formable material 132 and inserts it into first side saddle pad housing 121a through input valve 130 as shown. Arrow 133 indicate the flow of formable material in the internal cavity of first side saddle pad housing 121a.

The saddle pad housing 121 will generally include an internal cavity into which formable material is inserted through an input aperture or valve as the case may be. The saddle pad housing 121 may be constructed of any one of a number of different types of materials or structures, such as fabric material, tarp, and other types to form an internal cavity to contain or house the formable material. Once the formable material is injected or inserted into the internal cavity of the saddle pad housing 121, it will be generally dispersed throughout the internal cavity while it is still formable or moldable, and there will be contours such as those indicated by item numbers 135, 134 and 144, to name a few. Preferably the formable material will be spread out and relatively even before the mammal interface, in this case a saddle pad, is placed in the ultimate position it is to be used to mold the formable material to the desired contour between the mammal and the object it is interfacing with—in this example, a horse and a saddle.

Once the desired amount of formable material is within the internal cavity of the mammal interface, namely the saddle pad housing 121 of the saddle pad 120, then the input valve or input aperture is sufficiently closed so that it can retain the formable material during the molding or forming process. Once the saddle pad 120 in this example is placed on the horse in the correct position (over the blanket) and the saddle is placed thereon as it would be during use, the formable material within the internal cavity then moves in response to the forces imparted by the saddle and by the horse. This causes high points and low points and as the formable material begins to solidify, it has the effect of redistributing the forces from a local area to other areas and thereby removes sore spots or high pressure points. This redistribution of force or pressure results in a custom molding of the mammal interface, the saddle pad 120, for that specific saddle and that specific horse.

While there may be different formable materials that would be suitable for the mammal interface described herein, the following are potential materials: a silicon rubber compound mixture sold under the trademark “OOMOO 25” (the 25 representing the Durometer hardness test); a cure silicon rubber material (which is generally available alone or with additives to increase material properties such as viscosity, density, Durometer rating; a silicon rubber mixture referred to as Platinum 8 made by “Smooth-On”. It is preferred in the application referred to above to achieve a material hardness of approximately 25 or 30, having a material with a Durometer reading in the 10 to 50 range is contemplated in some embodiments of the invention.

In selecting the formable material, it is important that it be able to reasonably dry or solidify within an enclosed area such as the internal cavity of the mammal interface, namely the saddle pad housing 121. The examples given above seem particularly amenable to this type of application because of its drying characteristics and because when it solidifies it still has a combination of a solid structure or feel with a little bit softer outward gel cushion or softness. It is this combination of solid structure with an outer softness that makes the formable or moldable materials above preferable to other potential formable materials that may be utilized.

It will also be appreciated by those of ordinary skill in the art that there may be one or more housings and/or one or more internal cavities in each housing.

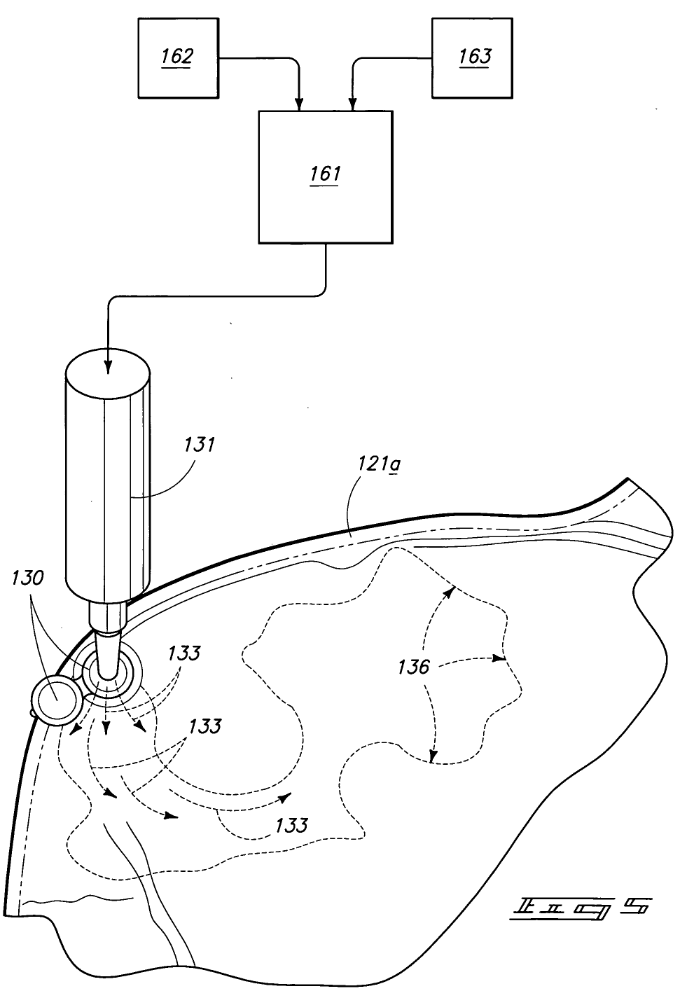

FIG. 5 is a bottom partial view of an embodiment of this invention and a schematic representation of one example of mixing two materials to provide a formable material to the internal cavity of the saddle pad in this example. FIG. 5 includes like numbered items from FIG. 4 and not all items will be repeated here. FIG. 5 illustrates how formable material may be mixed from two or more materials as represented by boxes 162 and 163. The mixture of formable material in box 161 is then inserted through insertion device 131 into the first side saddle pad housing 121a through input valve 130. While these examples show an insertion device such as insertion device 131, it will be noted that no actual device is required. Instead, the formable mixture may be spooned or dumped in before the internal cavity is sealed (or placed within the internal cavity in any one of a number of different ways and with any one of a number of different devices), all within the contemplation of this invention.

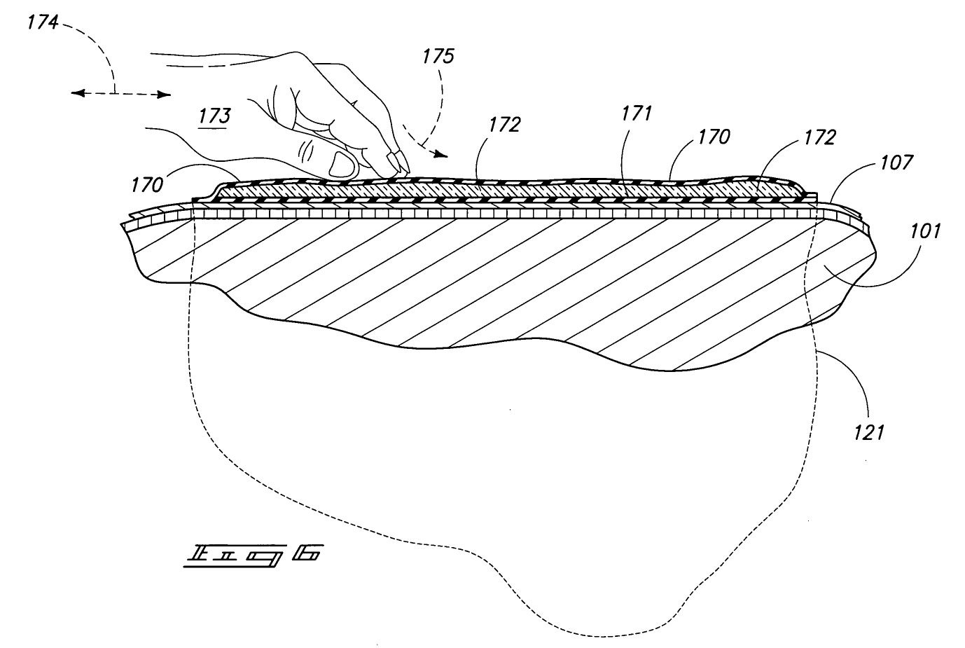

FIG. 5 further shows the movement of formable material as indicated by arrows 133 throughout the internal cavity of the first side saddle pad housing and forming contours illustrated by area 136. Again, when the formable material is initially inserted into the internal cavity it will typically not be uniformly distributed and some type of uniform distribution method may be required in some embodiments of this invention. FIG. 6 illustrates the use of a human hand to smooth out or make the distribution of the formable material within the internal cavity more uniform to be better positioned for molding. In other applications and embodiments, there may not be a need to smooth out or make the distribution of the formable material within the internal cavity more uniform, but instead the application of the mammal interface may take care of the redistribution of the formable material for molding (without any preparation required).

FIG. 6 is a partial elevation cross-sectional view of an example of an embodiment of this invention after the formable material is placed in the internal cavity and before it is custom formed for the application. FIG. 6 illustrates saddle pad housing 121, horse blanket 107 on horse (mammal) 101, outer containment housing wall 170, inner containment housing wall 171 and formable material 172 in the internal cavity formed between outer containment housing wall 170 and inner containment housing wall 171. A human hand 173 is shown smoothing out or making more uniform the distribution of formable material 172 within the internal cavity of the housing walls, with arrows 174 and 175 indicating movement of the hand and fingers.

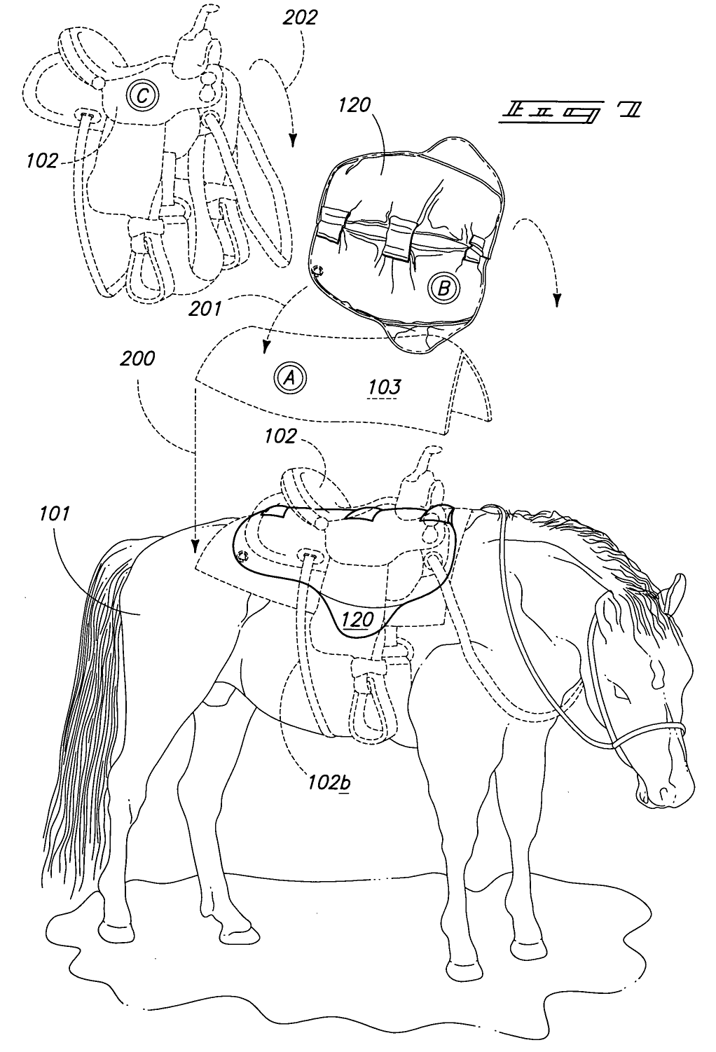

FIG. 7 is a perspective exploded view of an example of a mammal interface system contemplated by embodiments of this invention, showing a saddle 102, a saddle pad 120 and a blanket 103 as it is placed on a horse to custom form the mammal interface system. FIG. 7 illustrates a early step in the molding process and presumes that the formable material is within the internal cavity of the saddle pad 120. At this point as the formable material has not yet solidified. The blanket 103 is first placed on the horse 101 (step A) as indicated by arrow 200, and then the saddle pad 120 is placed over the blanket in its normal position as the next step, or step B, also as indicated by arrow 201. Once the saddle pad 120 is placed in the proper position on the blanket 103, the saddle 102 is placed over the saddle pad as indicated by the movement arrow 202 (step C). Once the saddle 102 is strapped around the horse by strap 102b and tightened to its normal position, the formable material or gel within the internal cavity of the saddle pad housing will move or redistribute itself based upon the magnitude of force and pressure between the saddle 102 and the horse 101. The formable material then be allowed to solidify to the extent that it solidifies and that saddle pad has then been customized for the saddle 102 and horse 101.

It will be appreciated by those in the art that it will be important to therefore consistently locate saddle pad 120 relative to saddle 102 to ensure that the contours and the solidified saddle pad 120 are always positioned correctly to the same relative position as when it was customized or formed. This may be accomplished by imparting markings or positioning markers on the saddle or on the saddle pad, to assure consistent placement. Another embodiment of a location system may also be utilized wherein fasteners such as snaps are placed on the saddle pad 120 and corresponding snaps or fasteners are placed on the saddle 102, all of which is described further in later figures. Thus during the formation or molding stage, the saddle pad 120 may be located by snapping the mating snap components, form the pad and then utilize the snaps to automatically locate the pad relative to the saddle each successive time.

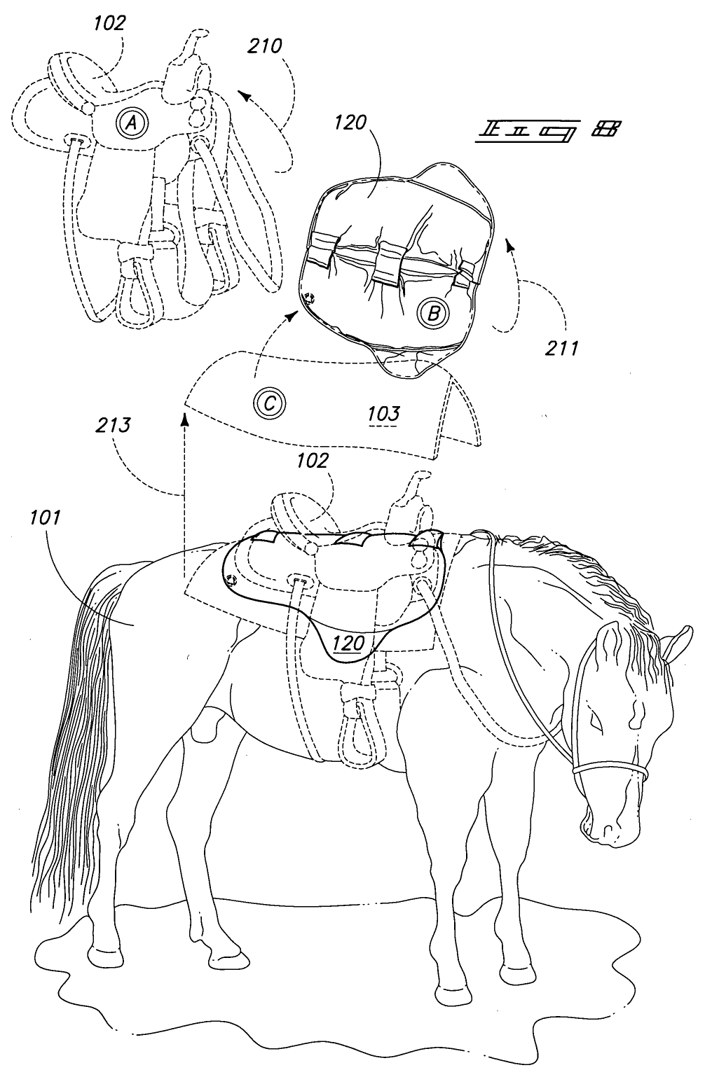

FIG. 8 is a perspective exploded view of an example of a mammal interface system contemplated by embodiments of this invention, showing a saddle 102, a saddle pad 120 and a blanket 103 as it is removed from the horse 101 after it has been custom formed as a mammal interface system. FIG. 8 illustrates that once the formable material has sufficiently solidified, the reverse process from that illustrated in FIG. 7 can then be utilized to remove the formed mammal interface system or in this case, custom saddle pad, from the horse. The saddle 102 is first unstrapped and removed as indicated by arrow 210 (Step A), followed by the removal of the saddle pad 120 as shown by arrow 211, and then the removal of blanket 103 as indicated by arrow 213. The resulting saddle pad 120 then provides the interface system between the horse 101 and the saddle 102 to greatly reduce or remove pressure points and sore spots for the horse 101.

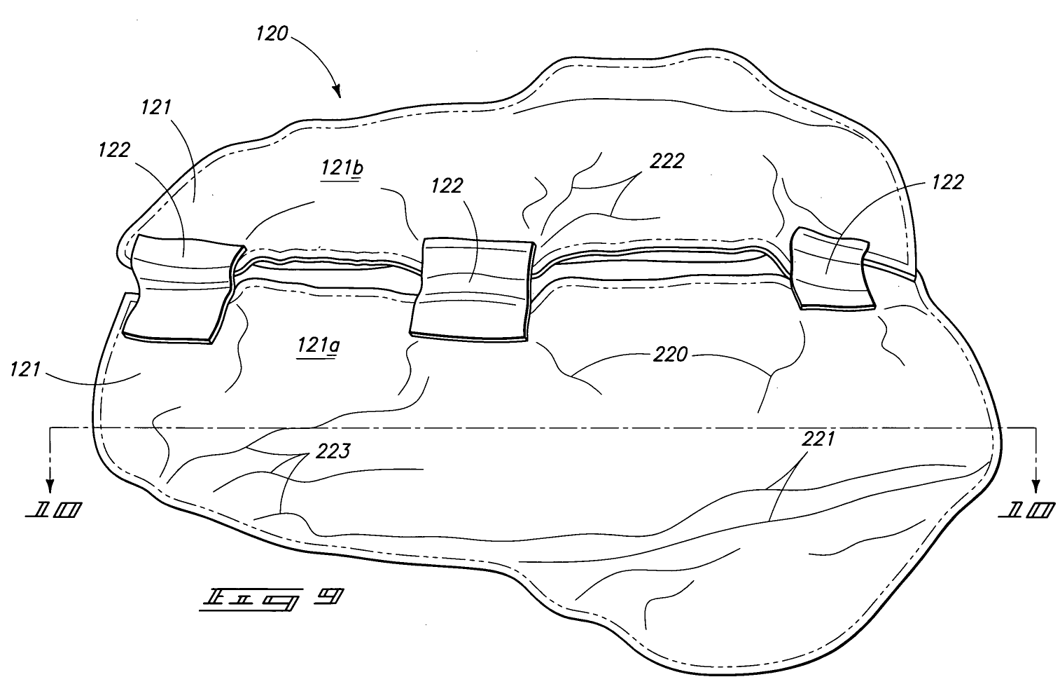

FIG. 9 is top perspective view of the embodiment of the mammal interface illustrated being custom formed in FIG. 8, namely the saddle pad 120. FIG. 9 includes like numbered items to prior figures and they will not be repeated here. FIG. 9 illustrates contours achieved as a result of the molding process shown in FIG. 7 and FIG. 8 and contours 220, 221, 222 and 223 show how the saddle pad 120 has been formed in a solidified way.

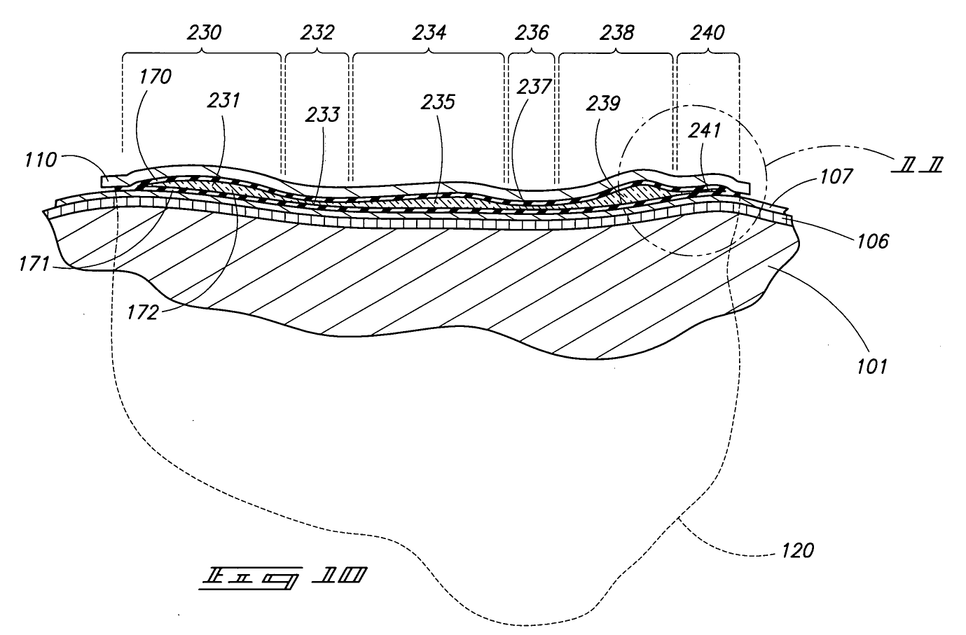

FIG. 10 is a partial elevation cross-sectional view of the mammal interface system illustrated in FIG. 9 showing areas of different forces or pressures in the custom fit configuration provided. FIG. 10 shows cross-sectional view 10-10 from FIG. 9 and illustrates different regions, zones or areas 230, 232, 234, 236, 238 and 240, each of which corresponds to a different area on the saddle pad 120 and generally to a different thickness of formable material in that zone. For instance, the formable material within the internal cavity of the saddle pad 120 zone 230 is material 231 and is generally thicker or there is more formable material. This would generally indicate that there was less force or pressure in zone 230 from the saddle 110 to the horse 101, and it did not displace as much formable material 231 in that zone. Zone 232 on the other hand shows less formable material 233 than in zone 230, generally indicating there was more force imparted between the saddle 110 and the animal. It is believed that having an area with a lesser thickness will cause the force otherwise imposed in zone 232 to the saddle and to the horse to be redistributed and borne by the portion of the saddle pad 120 in zone 230, and also the portion of the saddle pad in zone 234 which has more formable material 235 therein. Formable material 235 is thicker or more substantial than formable material 233 in zone 232 and the combination of zones 230 and 234 would then receive more pressure from the saddle and alleviate some of the additional pressure which appears present in zone 232.

Correspondingly, FIG. 10 shows zone 236 with formable material 237 in zone 236, formable material 239 in zone 238 and formable material 241 in zone 240. The formable material 241 in zone 240 is very thin and is likely therefore a location where more force or pressure is being applied from the saddle to the horse and therefore there is less formable material 241 within the internal cavity of the saddle pad at that location. Accordingly, it is believed that the formable material 239 within zone 238 is thicker and will receive some of the redistributed force or pressure that was otherwise being applied or localized in zone 240, thereby redistributing and spreading out the pressure or force in alleviating local hotspots or pain locations on the mammal.

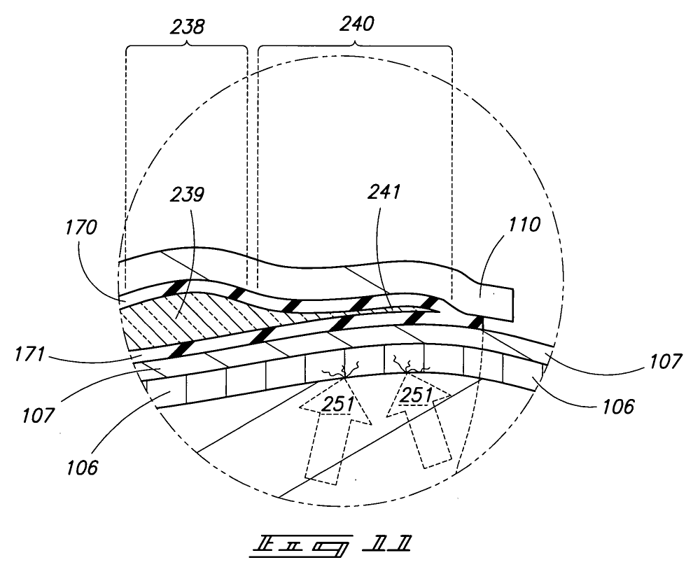

FIG. 11 is detail 11 from FIG. 10, and includes like numbered items from FIG. 10, which may not be repeated here. FIG. 11 better illustrates the slight amount of formable material 241 in zone 240 when compared to the formable material 239 with in zone 238. It will be noted how the formation of a relatively solid saddle pad will redistribute and spread out the pressure or forces otherwise imposed on local pressure points on the mammal, such as those indicated by arrows 251.

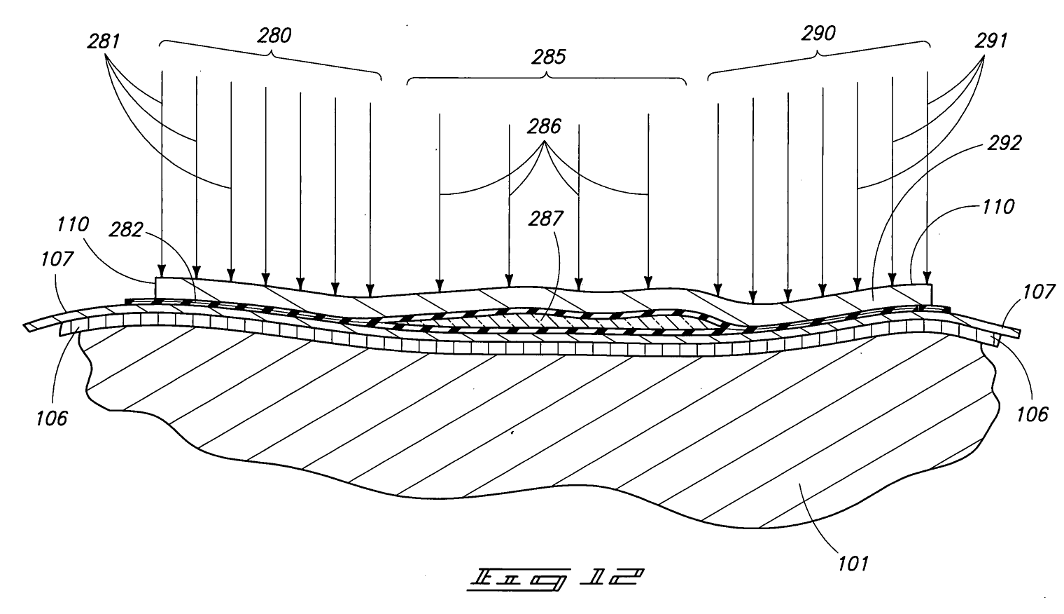

FIG. 12 is another partial elevation cross-sectional view of the mammal interface system illustrated in FIG. 9, further showing areas and magnitudes of force imposed in the application in which thereby contributes to the resulting configuration of the interface system. FIG. 12 illustrates more of how the formable material is believed to react to the magnitudes of force applied to the mammal from the saddle. Zone 280 shows force arrows 281 of a higher magnitude than force arrows 286 in zone 285 for example, thereby resulting in much less formable material 282 within the internal cavity of the saddle pad, as compared to the formable material 287 in zone 285 as a result of the lesser force arrows 286. Similarly, force arrows 291 or greater in magnitude in zone 290 and result in a much smaller amount of formable material 292 within the internal cavity of the saddle pad. The animal hide 106, saddle blanket 107 and saddle 110 are also shown in FIG. 12.

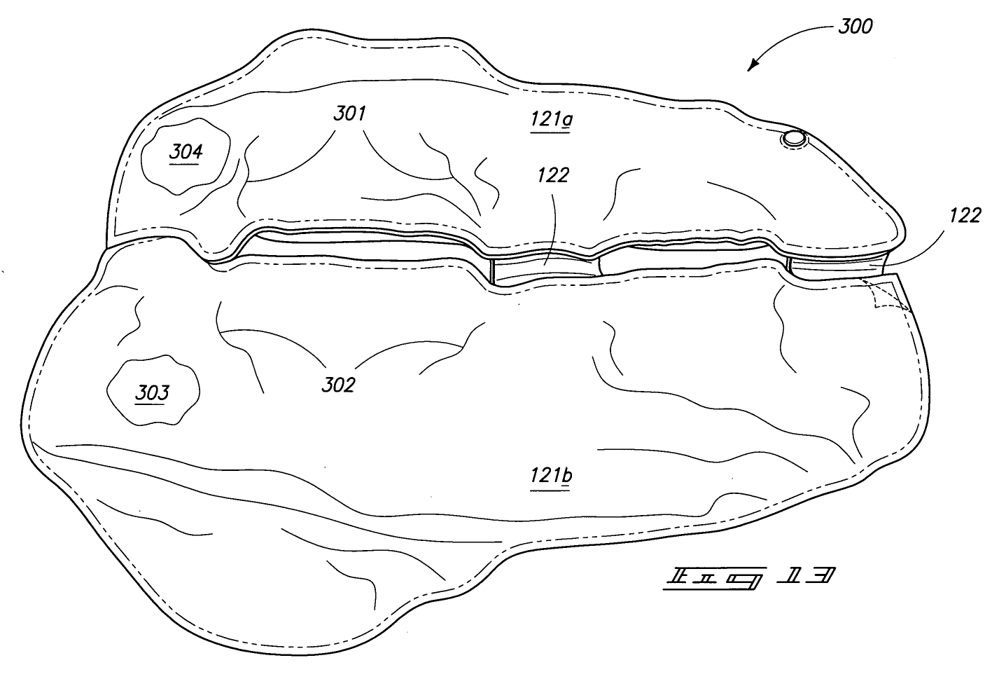

FIG. 13 is a bottom perspective view of an example of an embodiment of a mammal interface system contemplated by this invention, namely a saddle pad 300 customized for use with one saddle on one horse. This formed saddle pad 300 includes first side saddle pad housing 121a and second side saddle pad housing 121b with contours 301 and 304 in first side saddle pad housing 121a and contours 302 and 303 in second side saddle pad housing 121b. Connectors 122 are shown between the first side saddle pad housing 121a and second side saddle pad housing 121b.

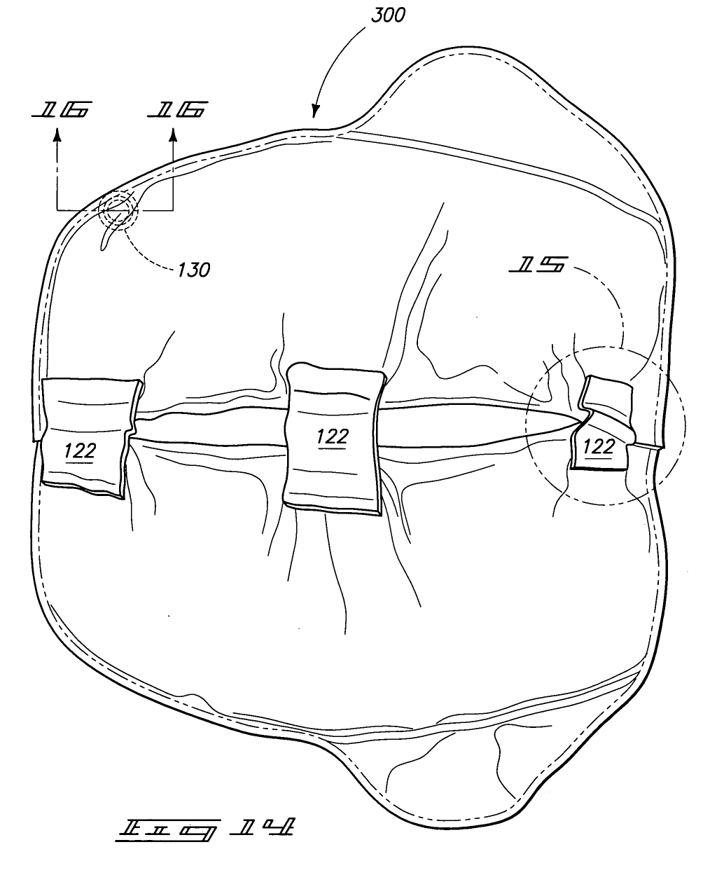

FIG. 14 is a top view of the example of the embodiment of the invention illustrated in FIG. 13. FIG. 14 shows connectors 122 between respective sides of the saddle pad 300, with input valve 130 also shown.

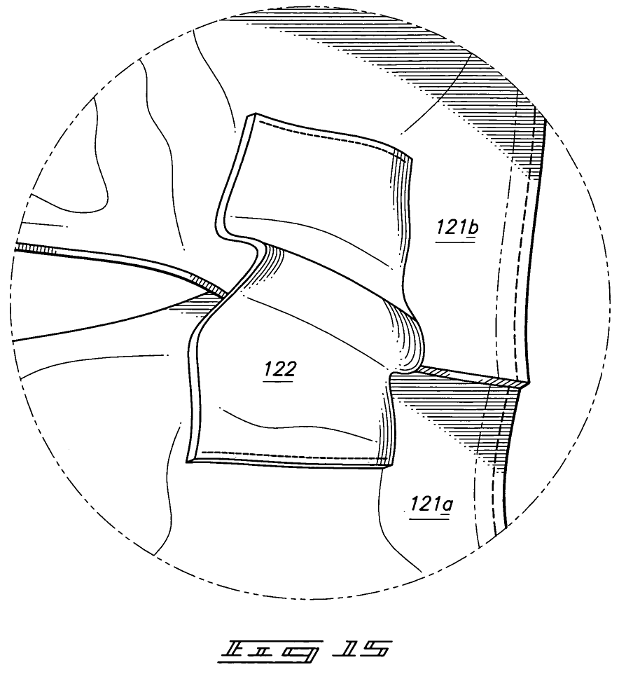

FIG. 15 is detail 15 from FIG. 14, and is a top view of a connector between two different parts of the example of the embodiment of the invention shown in FIG. 13. FIG. 15 shows connector 122 attached to the first side saddle pad housing 121a and second side saddle pad housing 121b. It will be appreciated that any one of a number of different types of connectors may be utilized with no one in particular being required to practice this invention. The connectors 122 may be a fabric or leather simply sewn to the respective saddle pad housings.

FIG. 16 is section 16-16 from FIG. 14, and is an elevation cross-sectional view of one example of a sealable input aperture 320 which may be utilized to insert formable material into the internal cavity of embodiments of interface systems contemplated by this invention. FIG. 16 illustrates input aperture 323, valve cover 321 what really moves as indicated by arrow 322 and arrow 324 shows the direction formable material would be inserted through input aperture 323 into internal cavity 325 within the saddle pad configuration. Saddle 102 is shown above the saddle pad 320, with first wall 326 and second wall 327 forming internal cavity 325 to receive and contain the formable material.

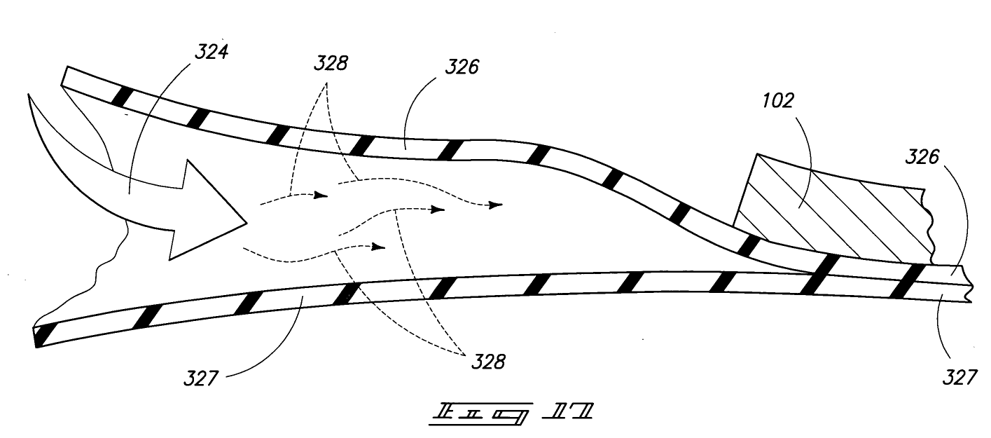

FIG. 17 is an elevation cross-sectional view of another example of an input aperture which may be utilized to insert formable material into the internal cavity of embodiments of interface systems contemplated by this invention. FIG. 17 illustrates how one corner or end of the saddle pad housing may be left open and the opening or aperture may be utilized to input a formable material into the internal cavity of the saddle pad. First housing wall 326 and second housing wall 327 form the internal cavity and receive and contain formable material indicated by arrows 328 as inserted by arrow 324.

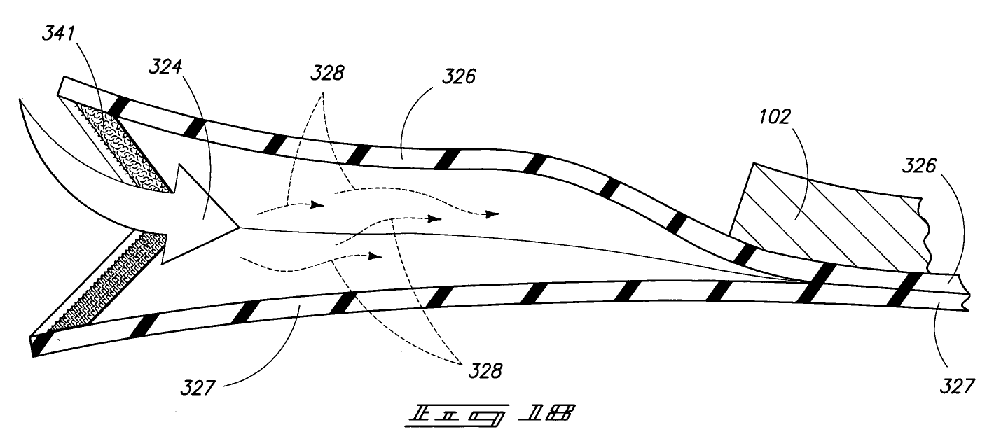

FIG. 18 is an elevation cross-sectional view of another example of an input aperture which may be utilized to insert formable material into the internal cavity of embodiments of interface systems contemplated by this invention, showing the use of hook and loop interface (“Velcro”) sealed the aperture after the formable material has been inserted into the internal cavity. FIG. 18 includes like numbered items from FIG. 17 and they will not be repeated here. FIG. 18 illustrates the insertion of the formable material through an aperture but also shows that Velcro 341 may be utilized to seal the aperture to contain the formable material during molding after it is inserted or injected into the internal cavity of the saddle pad.

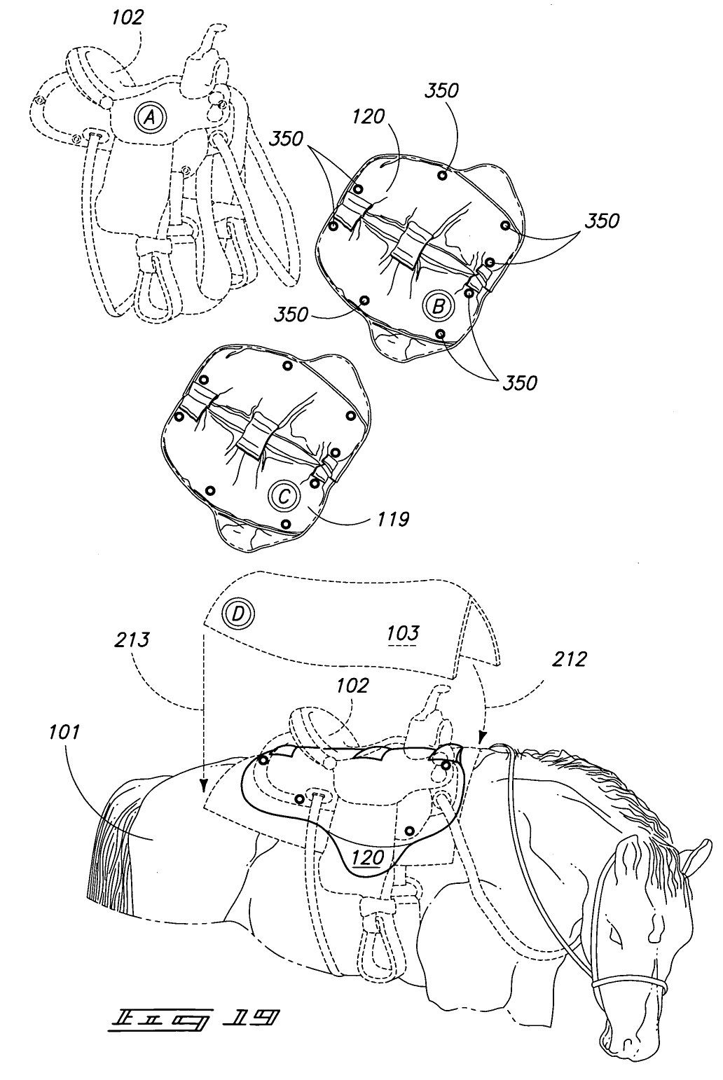

FIG. 19 is an exploded perspective view of another embodiment of this invention which provides a location system for consistently locating interface systems contemplated by this invention relative to the mammal 101 and in this example, the saddle 102. FIG. 19 also illustrates a system for providing interchangeable customized saddle pads 119 and 120 to enable one saddle 102 to be utilized on a different horse by merely substituting a saddle pad customized for that horse and properly located relative to the saddle 102. FIG. 19 illustrates a first customized saddle pad 119 and a second customized saddle pad 120, each customized in similar fashion to that described above, with the first customized saddle pad 119 being customized for one horse and the second customized saddle pad 120 being customized for a second horse.

The location system illustrated in FIG. 19 may be provided with snaps or other fasteners 350 which would be placed on the saddle pad and a corresponding snap component would also be placed upon the saddle 102 so that each saddle pad could be properly located relative to the saddle with which it was customized. There are like numbered items in FIG. 19 with FIG. 7 and FIG. 8, and each will not be fully described herein. This would insure that the saddle pad was located in the same location relative to the saddle 102 when the interface system is initially customized or formed to the horse and again when the saddle pad is utilized with the same horse.

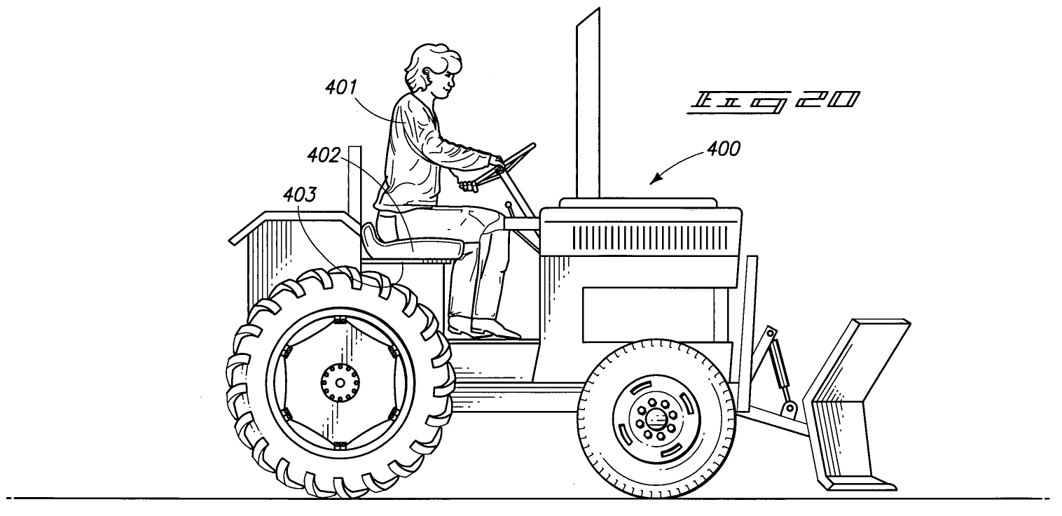

FIG. 20 is an elevation view of another embodiment of this invention wherein the interface system is provided as a mammal interface 402 between a human 401 and a tractor seat 403 of a tractor 400. The seat pad interface 402 can be formed and utilized in similar fashion to the saddle pad embodiment's shown and described more fully above.

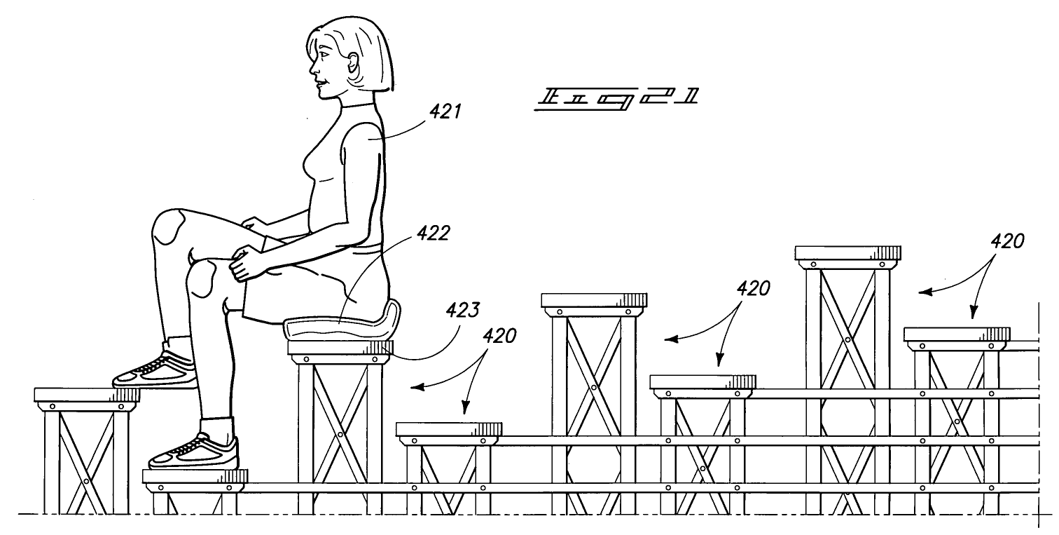

FIG. 21 is an elevation view of another embodiment of this invention wherein the interface system is designed for use on hard surfaces such as bleachers 420. In the embodiment illustrated in FIG. 21, provided is a mammal interface 422 between a human 421 and a bleacher 423 on which the human 421 is sitting. This interface may be formed and utilized in similar fashion to the saddle pad embodiments shown and described more fully above.

It will be noted that the interface systems shown in FIGS. 20 and 21 could also readily be utilized on top of a saddle for a horse for the benefit of the rider, in addition to being located between the saddle and the horse, all within the contemplation of this invention.

It will also be noted that the formable material within the at least one internal cavity has been specifically molded on a first side to the contour of a mammal and on a second side to an object. In the saddle example this would be molded to the saddle on a first side and to the horse (through the blanket) on the second side.

It will be appreciated that the interface system and pad may also be molded and fitted to be located between a rider of the horse and the saddle, all within the contemplation of the invention.

As will be appreciated by those of reasonable skill in the art, there are numerous embodiments to this invention, and variations of elements and components which may be used, all within the scope of this invention.

In one embodiment for example, a mammal interface system is provided which comprises: a housing with at least one internal cavity; a formable material within the at least one internal cavity, wherein the formable material has been specifically molded on a first side to the contour of a mammal and on a second side to an object, such that forces over the housing are redistributed. The forgoing embodiment may be further: wherein the formable material is a silicon rubber compound specifically molded to the shape of the mammal; wherein the formable material is a cure silicon rubber specifically molded to the shape of the mammal; wherein the formable material will set within the housing; and/or wherein the interface system is a saddle pad and the mammal is a horse.

In another embodiment, a method embodiment, a method for providing a mammal interface, comprising the following may be provided: providing a housing with at least one internal cavity and with an input aperture; mixing a first component and a second component of a formable material; inserting the formable material into the internal cavity of the housing through the input aperture; spreading the formable material throughout the internal cavity of the housing; placing the housing between a mammal and an object, thereby forcing the formable material to redistribute within the internal cavity of the housing; allowing the formable material to set and thereby forming to the shape of the mammal on a first side and forming to the shape of the object on the second side of the housing; and thereby creating a custom formed interface between the mammal and the object.

The forgoing embodiment may be further wherein the formable material is a silicon rubber compound specifically molded to the shape of the mammal; wherein the locations of higher compression in the interface are generally be thinner and locations of lower compression will generally be thicker; wherein the interface system is a saddle pad and the mammal is a horse; and/or wherein the interface system is a seat pad and the mammal is a human.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A mammal interface system, comprising:
a housing with at least one internal cavity;
a formable material within the at least one internal cavity, wherein the formable material has been specifically molded on a first side to the contour of a mammal and on a second side to an object, such that forces over the housing are redistributed.

2. A mammal interface system as recited in claim 1, and further wherein the formable material is a silicon rubber compound specifically molded to the shape of the mammal.

3. A mammal interface system as recited in claim 1, and further wherein the formable material is a cure silicon rubber specifically molded to the shape of the mammal.

4. A mammal interface system as recited in claim 1, and further wherein the formable material will set within the housing.

5. A mammal interface system as recited in claim 1, and further wherein the interface system is a saddle pad and the mammal is a horse.

6. A method for providing a mammal interface, comprising the following: providing a housing with at least one internal cavity and with an input aperture;
mixing a first component and a second component of a formable material; inserting the formable material into the internal cavity of the housing through the input aperture;
spreading the formable material throughout the internal cavity of the housing;
placing the housing between a mammal and an object, thereby forcing the formable material to redistribute within the internal cavity of the housing;
allowing the formable material to set and thereby forming to the shape of the mammal on a first side and forming to the shape of the object on the second side of the housing; and
thereby creating a custom formed interface between the mammal and the object.

7. A method for providing a mammal interface as recited in claim 6, and further wherein the formable material is a silicon rubber compound specifically molded to the shape of the mammal

8. A method for providing a mammal interface as recited in claim 6, and further wherein the locations of higher compression in the interface are generally be thinner and locations of lower compression will generally be thicker.

9. A method for providing a mammal interface as recited in claim 6, and further wherein the interface system is a saddle pad and the mammal is a horse.

10. A method for providing a mammal interface as recited in claim 6, and further wherein the interface system is a seat pad and the mammal is a human.
